(19) United States
(12) Patent Application Publication
(10) Pub. No.: US 2021/0060803 A1
(43) Pub. Date: Mar. 4, 2021

(54) HAIR TRIMMING APPARATUS

(71) Applicant: Ideavillage Products Corp., Wayne, NJ (US)

(72) Inventors: LoriAnn Lombardo, East Hanover, NJ (US); Lana Rascionato, Totowa, NJ (US); Anand Khubani, Morristown, NJ (US); David Stowers, Morristown, NJ (US)

(21) Appl. No.: 17/097,610

(22) Filed: Nov. 13, 2020

Related U.S. Application Data
(63) Continuation-in-part of application No. 14/544,863, filed on Feb. 26, 2015.
(60) Provisional application No. 61/966,668, filed on Mar. 4, 2014.

(51) Int. Cl. B26B 19/10; B26B 19/38; B26B 19/20; B26B 19/46

(52) U.S. Cl. CPC B26B 19/107; B26B 19/3886; B26B 19/3853; B26B 19/46; B26B 19/3833; B26B 19/20

(57) ABSTRACT

The present invention provides for a hair trimming apparatus having a first precision hair trimmer and a second utility hair trimmer and a switch plate to switch the active mode from the first trimmer to the second trimmer and back to the first trimmer.

### RELATED APPLICATION

This application is a continuation-in-part of U.S. application Ser. No. 14/544,863 entitled “HAIR TRIMMING APPARATUS” filed on Feb. 26, 2015 which is related to U.S. Provisional Application Ser. No. 61/966,668 entitled “Hair Trimming Apparatus” which was filed on Mar. 4, 2014.

### BACKGROUND OF THE INVENTION

### Field of the Invention

This invention relates to a hair trimming apparatus and more specifically, to a hair trimming apparatus with two hair trimmers and a means for switching from first trimmer to the second trimmer and back to the first trimmer. The switching means may be a sliding mechanism, a pivoting mechanism, or a twisting mechanism.

### SUMMARY OF THE INVENTION

In one embodiment, the present invention provides for a hair trimming apparatus comprising: a housing having opposing ends; a first precision hair trimmer situated on a first end of the housing of the apparatus, the first trimmer comprises at least one movable blade and at least one stationary blade, and the movable blade moves relative to the stationary blade to create a first cutting action; a second utility hair trimmer situated on a second end of the housing of the apparatus opposite of the first trimmer, and the second trimmer comprises at least one movable blade and at least one stationary blade, the movable blade moves relative to the stationary blade to create a second cutting action; and a movable switch plate situated on the housing, and the switch plate covers at least a portion of the blades of the second trimmer in a first position during the first cutting action, and switch plate is moved to expose the blades of the second trimmer in a second position during the second cutting action.

In another embodiment, the apparatus further comprises at least one motor designed to drive the blades in the first and second trimmers independently of one another to thereby create the first and second cutting actions.

In yet another embodiment, the apparatus further comprises at least two motors, and the first motor is designed to drive the blades of the first trimmer and second motor is designed to drive the blades of the second trimmer.

In still another embodiment, the apparatus further comprises an on/off button to activate the first and second trimmers. In still yet another embodiment, the apparatus further comprises a power source. In a further embodiment, the power source is a battery. In yet a further embodiment, the apparatus further comprises a compartment, and the compartment designed to store the motor and the power source.

In still a further embodiment, the type of switch plate is selected from a group consisting essentially of sliding switch plates, pivoting switch plates and twisting switch plates and combinations thereof.

In yet still a further embodiment, the apparatus further comprises at least one guide for the first and second trimmers, and the guides are attachable and removable relative to the trimmers, and the guides are designed to determine the length of the hair that is cut. In another embodiment, the switch plate functions as part of a handle for the housing during the first position.

In yet another embodiment, the apparatus further comprises at least one light. In still another embodiment, the apparatus further comprises at least one brush for cleaning the blades. In still yet another embodiment, the apparatus further comprises at least one cover for the first trimmer.

In another embodiment, the present invention provides for a hair trimming apparatus comprising: a housing having opposing ends; a first precision hair trimmer situated on a first end of the housing of the apparatus, the first trimmer comprises at least one movable blade and at least one stationary blade, the movable blade moves relative to the stationary blade to create a first cutting action; a second utility hair trimmer situated on a second end of the housing of the apparatus opposite of the first trimmer, the second trimmer comprises at least one movable blade and at least one stationary blade, the movable blade moves relative to the stationary blade to create a second cutting action; and at least one movable switch plate that covers the second trimmer in a first position when the first trimmer is active, and the switch plate covers the first trimmer in a second position when the second trimmer is active.

In a further embodiment, the present invention relates to a hair trimming apparatus comprising: a housing having opposing ends; a first hair trimmer situated on a first end of the housing of the apparatus, the first trimmer comprises at least one movable blade, and the movable blade moves to create a first cutting action; a second hair trimmer situated on a second end of the housing of the apparatus opposite of the first trimmer, said second trimmer comprising at least one movable blade, and the movable blade moves to create a second cutting action; at least one motor for driving the first and second cutting action; and a means for switching from the first cutting action to the second cutting action and then switching back to the first cutting action.

In another further embodiment, there are at least two precision hair trimmers. In still another further embodiment, there are at least two precision hair trimmers. For purposes of this invention, precision hair trimmers are used for small volume of hair and tough to reach places and utility hair trimmers are used for larger volumes of hair.

### BRIEF DESCRIPTION OF THE DRAWINGS

The accompanying drawings are included to provide a further understanding of the present invention. These drawings are incorporated in and constitute a part of this specification, illustrate one or more embodiments of the present invention and together with the description, serve to explain the principles of the present invention.

FIG. 1 is a perspective view of one of the embodiments of the present invention;

FIG. 2 is a side view of FIG. 1;

FIG. 3 is a side view of an embodiment of the present invention showing the first position of the switch plate;

FIG. 4 is a side view of an embodiment showing the second position of the switch plate;

FIG. 5 is a side view of an embodiment showing the second position of the switch plate;

FIG. 6 is a side view on an embodiment showing the present invention with a motor;

FIG. 7 is side view of an embodiment showing the present invention with two motors and a battery;

FIG. 8 is a side view of an embodiment with a brush;

FIG. 9 is a side view of an embodiment showing a pivoting switch plate and a cap; and

FIG. 10 is a side view of an embodiment showing a twisting plate, a cap, and a comb.

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

### DETAILED DESCRIPTION OF THE INVENTION

As required, detailed embodiments of the present invention are disclosed herein; however, it is to be understood that the disclosed embodiments are merely exemplary of the invention that may be embodied in various forms. The figures are not necessarily to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

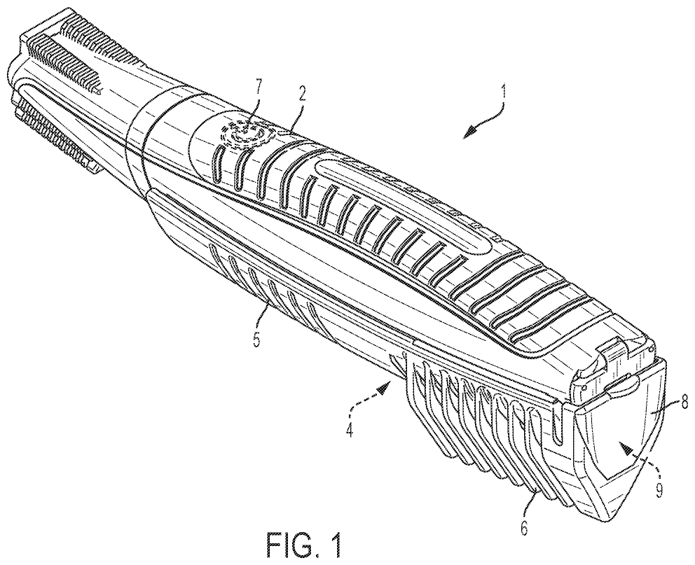

FIG. 1 depicts the hair trimming apparatus 1 of the present invention showing the housing 2 with the first precision hair trimmer 3 and the second utility hair trimmer 4 on the opposing end of the housing 2. The apparatus 1 also has a movable switch plate 5 and guide 6. There is an on/off button 7 on the housing 2 and a door 8 leading to the internal compartment 9 for storing the motor, transmission, and power source (batteries). There is a light 10 and grips 11 on the housing 2.

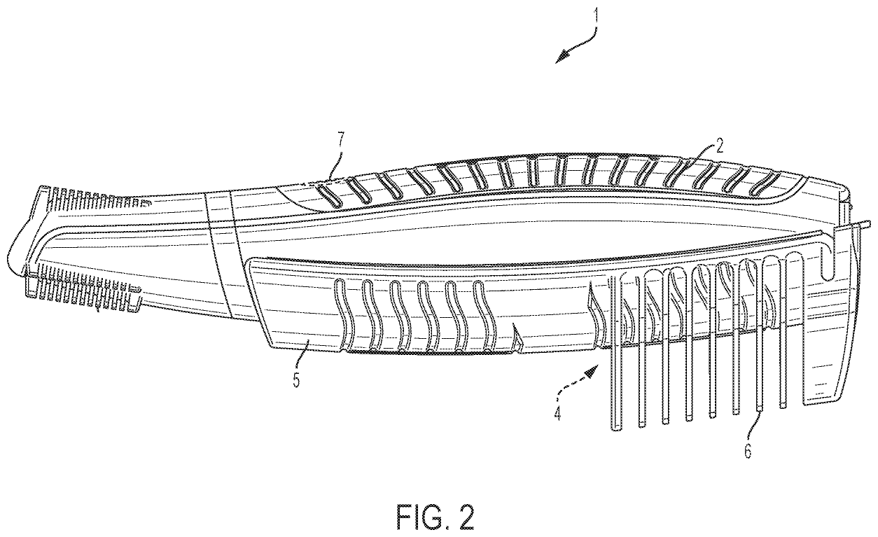

FIG. 2 depicts a side view of the hair trimming apparatus 1 showing combs (guides) 6a and 6b over first hair trimmer 3 and second hair trimmer 4.

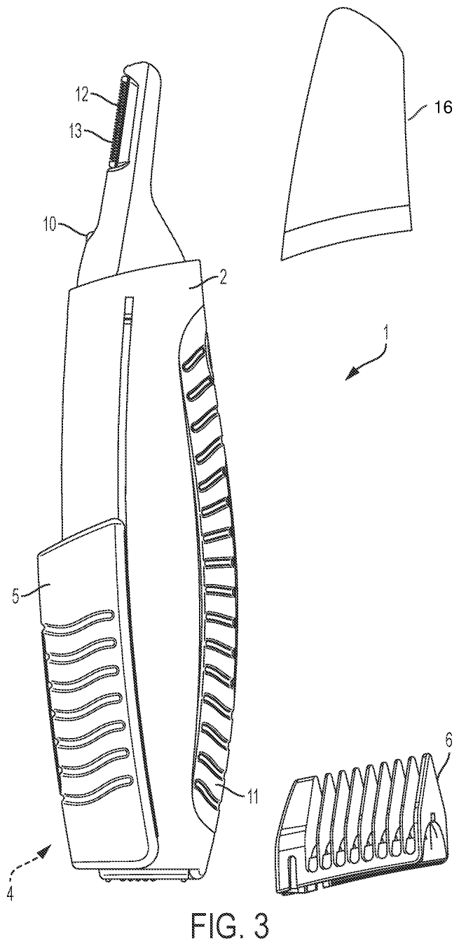

FIG. 3 shows the movable switch plate 5 is in the first position where it covers the second utility hair trimmer 4 and allows for use of the first precision hair trimmer 3. It further shows stationary blades 12 and movable blades 13 of the first trimmer 3. If further shows a cap 16 and detached comb 6. The switch plate 5 is capable of sliding, twisting or pivoting from a first position to a second position. The switch plate 5 controls which trimmer is powered on and which trimmer is powered off. The location of the switch plate 5 causes the power to be moved from first trimmer 3 to second trimmer 4 and vice versa. The switch plate 5 in the first position powers on the first trimmer 3 and covers the second trimmer 4.

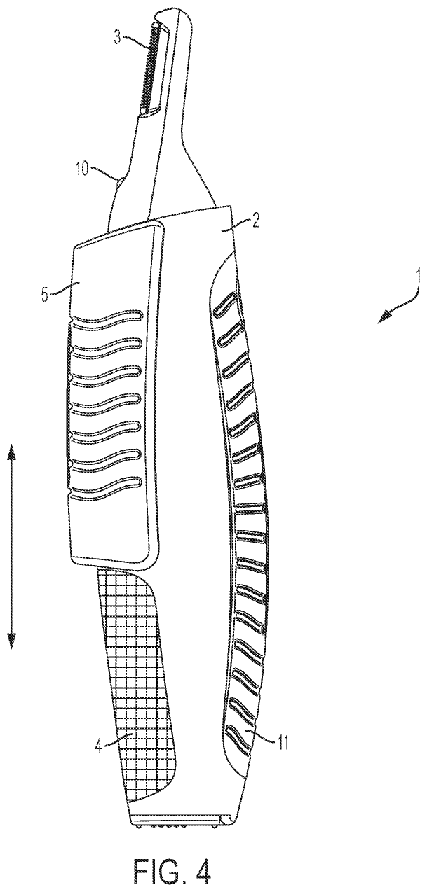

FIG. 4 illustrates how switch plate 5 is moved to a second position thereby exposing the second utility hair trimmer 4 during its use position or mode. It further shows the second trimmer 4 having a foil type cutting device. The switch plate 5 in the second position exposes the second trimmer 4 and provides power to the second trimmer 4.

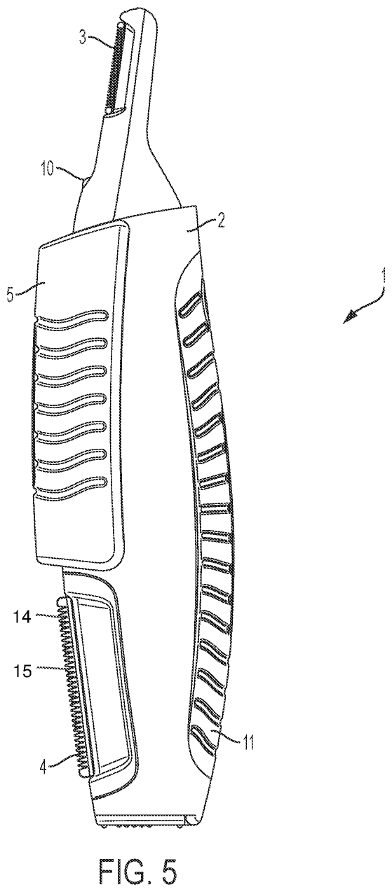

FIG. 5 shows the switch plate 5 moved to a second position there by exposing the second trimmer 4 with its stationary blades 14 and movable blades 15. It also shows a light 10 located underneath the first trimmer 3. It further shows the grip 11 which runs along the length of the apparatus 1. The grip 11 could run the entire length of the housing 2, around the entire circumference of the housing 2, and any portion thereof of the housing.

FIGS. 3-5 shows a switch plate that slides between a first and a second position.

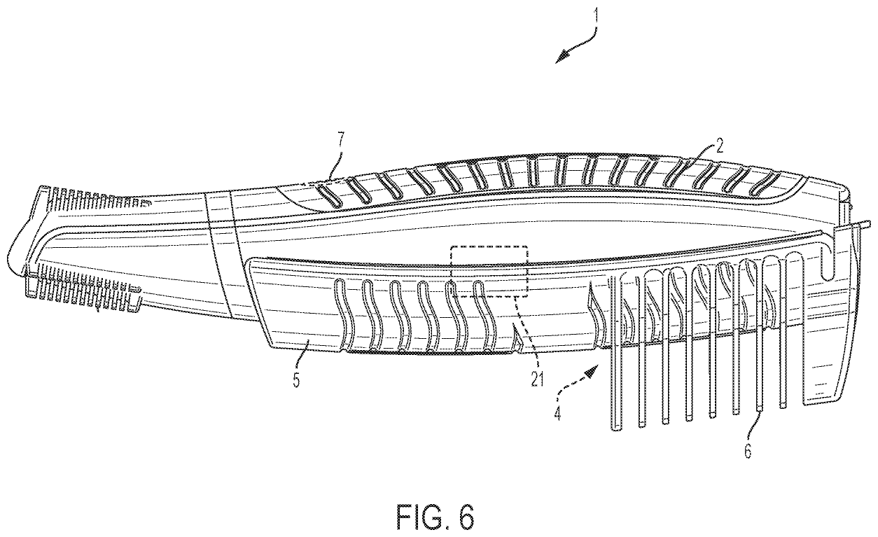

FIG. 6 shows the internal location of a motor 21 inside the internal compartment 9.

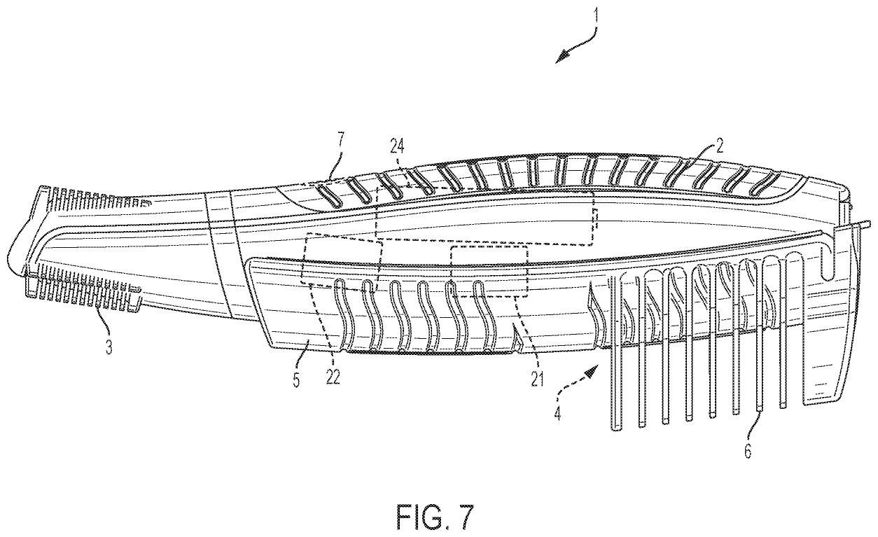

FIG. 7 shoes the internal location of a motor 21, another motor 22, and a battery 24 inside the internal compartment 9. Motor 21 interacts with a transmission (not shown) that drives the stationary blades 12 and movable blade 13 of the first trimmer 3. Motor 22 interacts with a transmission (not shown) that drives the stationary blades 14 and movable blade 15 of the second trimmer 4. Motor 21 interacts with a transmission (not shown) that drives the stationary blades 14 and movable blade 15 of the second trimmer 4. Battery 24 powers motor 21 and/or motor 22.

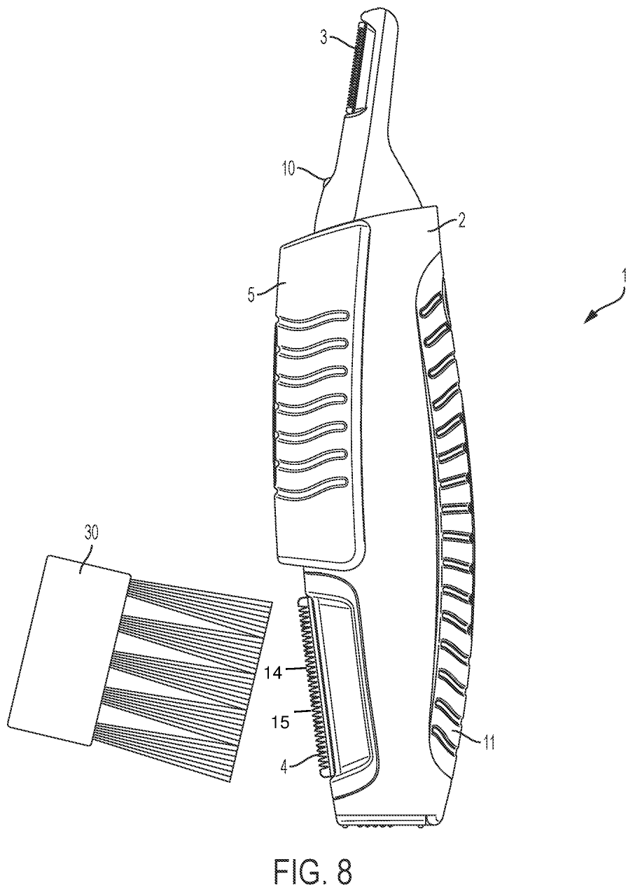

FIG. 8 shows apparatus 1 with a brush 30 to clean the trimmers.

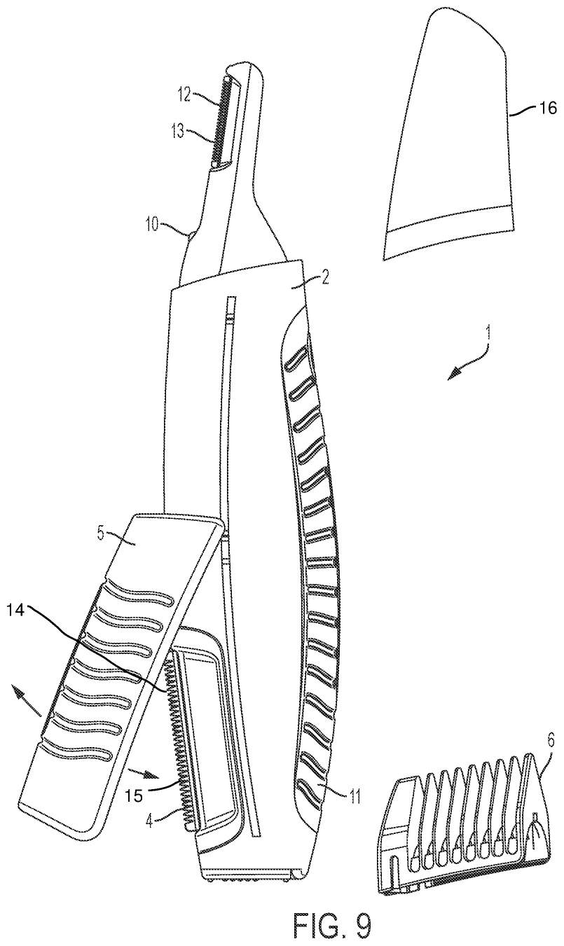

FIG. 9 shows a switch plate 5 that is capable of pivoting from a first position to a second position to control which trimmer is powered on.

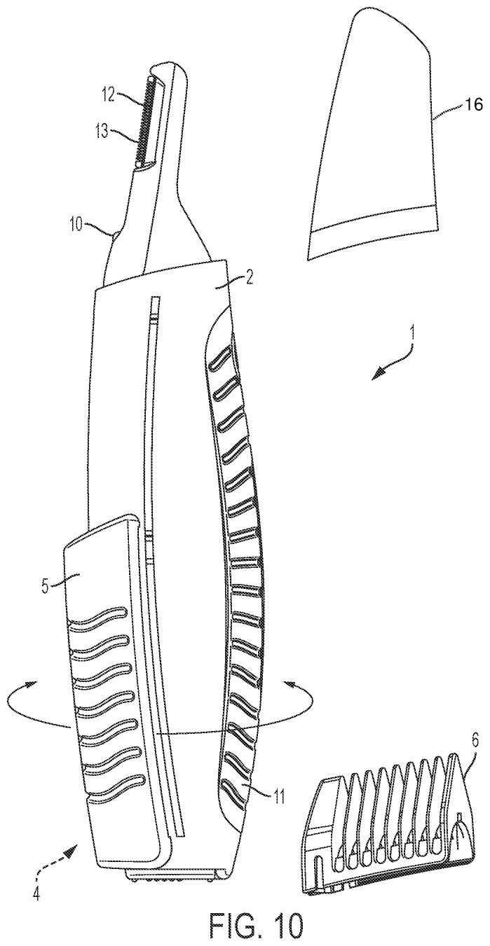

FIG. 10 shows a switch plate 5 that is capable of twisting from a first position to a second position to control which trimmer is powered on.

The mechanism including, but limited to the device for moving the movable element and the pivoting mechanism can be used and interchanged to form various embodiments of the present invention. Numerous modifications and variations of the present invention are possible in light of the above teachings. It is therefore to be understood that within the scope of the attendant claims attached hereto, this invention may be practiced otherwise than as specifically disclosed herein.

What is claimed is:

1. A hair trimming apparatus comprising:
a housing having opposing ends;
a first precision hair trimmer situated on a first end of said housing of said apparatus, said first trimmer comprising at least one movable blade and at least one stationary blade, said movable blade moves relative to said stationary blade to create a first cutting action;
a second utility hair trimmer situated on a second end of said housing of said apparatus opposite of said first trimmer, said second trimmer comprising at least one movable blade and at least one stationary blade, said movable blade moves relative to said stationary blade to create a second cutting action; and
a movable switch plate situated on said housing which controls which of said trimmers received power, said switch plate covers at least a portion of said blades of said second trimmer in a first position during said first cutting action, said switch plate is moved to expose said blades of said second trimmer in a second position during said second cutting action.

2. The apparatus of claim 1 further comprising at least one motor and at least one transmission designed to drive said movable blades in said first and second trimmers independently of one another to thereby create said first and second cutting actions.

3. The apparatus of claim 1 further comprising at least two motors and at least two transmission, said first motor and said first transmission are designed to drive said blades of said first trimmer and second motor and second transmission are designed to drive said blades of said second trimmer.

4. The apparatus of claim 1 further comprising an on/off button to activate said first and second trimmers.

5. The apparatus of claim 2 further comprising a power source.

6. The apparatus of claim 5 wherein said power source is a battery.

7. The apparatus of claim 2 further comprising a compartment, said compartment designed to store said motor, said transmission and said power source.

8. The apparatus of claim 1 wherein the type of said switch plate is selected from a group consisting essentially of sliding switch plates, pivoting switch plates and twisting switch plates and combinations thereof.

9. The apparatus of claim 1 further comprising at least one guide for said first and second trimmers, said guides are attachable and removable relative to said trimmers, said guides are designed to determine the length of the hair that is cut.

10. The apparatus of claim 1 wherein said switch plate functions as part of a handle for said housing during said first position.

11. The apparatus of claim 1 further comprising at least one light.

12. The apparatus of claim 1 further comprising at least one brush for cleaning said blades.

13. A hair trimming apparatus comprising:
a housing having opposing ends;
a first precision hair trimmer situated on a first end of said housing of said apparatus, said first trimmer comprising at least one movable blade and at least one stationary blade, said movable blade moves relative to said stationary blade to create a first cutting action;
a second utility hair trimmer situated on a second end of said housing of said apparatus opposite of said first trimmer, said second trimmer comprising at least one movable blade and at least one stationary blade, said movable blade moves relative to said stationary blade to create a second cutting action; and
at least one movable switch plate that controls what trimmer receives power, said moveable switch plate that covers said second trimmer in a first position when said first trimmer is active, said switch plate covers said first trimmer in a second position when said second trimmer is active.

14. The apparatus of claim 13 further comprising at least one motor and one transmission designed to drive said blades in said first and second trimmers independently of one another to thereby create said first and second cutting actions.

15. The apparatus of claim 13 further comprising at least two motors and two transmissions, said first motor and said first transmission are designed to drive said movable blades of said first trimmer and second motor and second transmission are designed to drive said movable blades of said second trimmer.

16. The apparatus of claim 13 further comprising an on/off button to activate said first and second trimmers.

17. The apparatus of claim 14 further comprising a power source.

18. The apparatus of claim 15 wherein said power source is a battery.

19. The apparatus of claim 14 further comprising a compartment situated within said housing, said compartment designed to store said motor, said transmission and said power source.

20. The apparatus of claim 13 wherein the type of said switch plate is selected from a group consisting essentially of sliding switch plates, pivoting switch plates and twisting switch plates and combinations thereof.

21. The apparatus of claim 13 further comprising at least one guide for said first and second trimmers, said guides are attachable and removable relative to said trimmers, said guides are designed to determine the length of the hair that is cut.

22. The apparatus of claim 13 further comprising at least one light.

23. The apparatus of claim 13 further comprising at least one brush for cleaning said blades.

24. The apparatus of claim 1 further comprising at least one cover for said first trimmer.

25. A hair trimming apparatus comprising:
a housing having opposing ends;
a first hair trimmer situated on a first end of said housing of said apparatus, said first trimmer comprising at least one movable blade, said movable blade moves to create a first cutting action;
a second hair trimmer situated on a second end of said housing of said apparatus opposite of said first trimmer, said second trimmer comprising at least one movable blade, said movable blade to create a second cutting action;
at least one motor for driving said first and second cutting action; and
a switch plate for switching from said first cutting action to said second cutting action and then switching back to said first cutting action.
